(19) United States
(12) Patent Application Publication
(10) Pub. No.: US 2005/0047507 A1
(43) Pub. Date: Mar. 3, 2005

(54) EFFICIENT VIDEO CODEC SYSTEM AND RELATED METHOD

(76) Inventor: Chi-Cheng Ju, Hsin-Chu City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/711,139

(22) Filed: Aug. 27, 2004

(30) Foreign Application Priority Data
Aug. 28, 2003 (TW) 092123830

(51) Int. Cl. H04N 7/12

(52) U.S. Cl. 375/240.12; 375/240.25

(57) ABSTRACT

A video signal processing system is utilized for encoding an encoding bit stream according to characteristics of a decoding bit stream. The encoding and decoding bit streams include a plurality of encoding schemes. The video signal encoding and decoding method includes: checking the encoding scheme of the decoding bit stream to decide an encoding scheme for encoding the encoding bit stream; and encoding the encoding bit stream using one of the plurality of encoding schemes except a third encoding scheme when the encoding scheme of the decoding bit stream is the third encoding scheme, the memory bandwidth needed for the third encoding scheme being greater than the memory bandwidth needed for any other encoding scheme out of the plurality of encoding schemes.

### BACKGROUND

The present invention relates to a video signal processing system and more specifically, to an efficient video codec system and a method thereof.

As the computing speed of electronic circuits is rapidly increasing, computations that consume more system resources (e.g.: video signal processing) become more critical when designing an electronic devices. A general specification for video signal processing usually includes several encoding schemes to meet the need for encoding all kinds of video data. The MPEG (Moving Picture Experts Group) specification is given as an example. In the MPEG specification, encoding a picture can be according to the following encoding schemes: intra encoding, predictive encoding, or bidirectionally predictive encoding. An intra encoded picture (I-picture) corresponding to a target picture is generated using only the target picture's own information. A predictive encoded picture (P-picture) is generated by using a previous reference picture which can be an I-picture or a P-picture, and the technique is called forward prediction. Hence, it is necessary to use the previous reference picture when decoding the predictive encoded picture. Predictive encoded pictures provide more compression than that provided by intra encoded pictures and serve as reference pictures for bidirectionally predictive encoded pictures (B-pictures, described below) and future P-pictures. (I-pictures may also serve as reference pictures for B-pictures.) Additionally, a bidirectionally predictive encoded picture (B-picture) is generated by using both a previous picture and a future picture as reference pictures. Therefore, it is necessary to use the previous reference picture and the future reference picture when decoding the bidirectionally predictive encoded picture. The previous reference picture can be an I-picture or a P-picture, and the future reference picture can be an I-picture or a P-picture. Bidirectional predictive encoded pictures provide the most compression, and do not propagate errors because they are never used as reference pictures.

According to the above-mentioned description about different kinds of pictures, when encoding or decoding an intra encoded picture, it is not necessary to refer to the previous or the future picture(s) and therefore the least memory bandwidth is required. Additionally, when encoding or decoding a predictive encoded picture, it is necessary to refer to the previous reference picture(s) and therefore more memory bandwidth is required. In the same manner, when encoding or decoding a bidirectionally predictive encoded picture, it is necessary to refer to the previous and the future reference picture(s) and therefore the most memory bandwidth is required.

Continuing, a picture includes a plurality of macroblocks, wherein when encoding or decoding a picture, a macroblock is the unit of operation. Each macroblock of a picture includes a macroblock type parameter that is utilized for representing the encoding scheme of the macroblock. MPEG-2 (Motion Picture Experts Group 2) is given as an example. The encoding scheme of a macroblock of an intra encoded picture is the intra encoding; the encoding scheme of a macroblock of a predictive encoded picture can be intra encoding or forward motion compensation encoding; the encoding scheme of a macroblock of a bidirectionally predictive encoded picture can be intra encoding, forward motion compensation encoding, backward motion compensation encoding or bidirectional motion compensation encoding. Wherein the forward motion compensated macroblock or the backward motion compensated macroblock can be called a unidirectional motion compensated macroblock. An intra encoded macroblock is a macroblock that is encoded independently. This means that when encoding or decoding an intra encoded macroblock, it is not necessary to refer to the previous or the future picture(s). When encoding or decoding a unidirectional motion compensated macroblock, it is necessary to read the predictive data from the previous or the future reference picture(s). Furthermore, when encoding or decoding a bidirectional motion compensated macroblock, it is necessary to read the forward predictive data and the backward predictive data from the previous and the future reference picture(s).

According to the above-mentioned description about different kinds of macroblocks, when encoding or decoding an intra encoded macroblock, it is not necessary to refer to the previous or the future picture(s) and therefore the least memory bandwidth is required. However, when encoding or decoding a unidirectional motion compensated macroblock, it is necessary to refer to the previous or the future reference picture(s) and therefore more memory bandwidth is required. In the same manner, when encoding or decoding a bidirectionally motion compensated macroblock, it is necessary to refer to the previous and the future reference picture(s) and therefore the most memory bandwidth is required.

Please refer to FIG. 1. FIG. 1 is a functional diagram of a video signal processing system 100 according to the related art. The video signal processing system 100 includes an encoder 102, a decoder 104, a memory interface circuit 106 and a memory 108. The encoder 102 and the decoder 104 both use the same memory interface circuit 106 to access the data stored in the same memory 108 in order to encode or decode. Wherein during an encoding process, the encoder 102 compresses the image data to several pictures, such as an intra encoded picture, a predictive encoded picture or a bidirectionally predictive encoded picture, and the picture sequence composed of the several pictures is the picture sequence S1. At the same time, the decoder 104 decodes a decoding bit stream having a picture sequence S2 composed of an intra encoded picture, a predictive encoded picture or a bidirectionally predictive encoded picture. In the related art, the picture sequence S1 is irrelevant to the picture sequence S2 and the picture sequence for encoding is predetermined for the video signal processing system 100. For example, the predetermined picture sequence is “the intra encoding, the predictive encoding, the bidirectionally predictive encoding, the bidirectionally predictive encoding, the intra encoding, the predictive encoding, the bidirectionally predictive encoding, the bidirectionally predictive encoding, . . . ”. The encoder 102 according to the related art encodes according to the above-mentioned predetermined picture sequence. However, when the encoder 102 is encoding a first bidirectionally predictive encoded picture and when the decoder 104 is simultaneously decoding a second bidirectionally predictive encoded picture, the encoder 102 and the decoder 104 are simultaneously in the computing mode that consumes the maximum memory bandwidth. Therefore, suddenly, much more memory bandwidth is required. Additionally, the encoder 102 and the decoder 104 both use the same memory interface circuit and the same memory device. Hence, in some moments, the memory bandwidth provided by the video signal processing system 100 is not sufficient for encoding the first bidirectionally predictive encoded picture and decoding the second bidirectionally predictive encoded picture at the same time. This induces greatly lowering the computing speed of encoding or decoding, and therefore, the video signal processing system 100 cannot meet the requirement for real-time encoding and decoding.

Furthermore, the encoder 102 decides the encoding scheme of each macroblock of a picture (the macroblock may be an intra encoded macroblock, a unidirectional motion compensated macroblock or a bidirectional motion compensated macroblock), and the macroblock sequence of the encoding schemes of the macroblocks of a picture is a macroblock sequence S3. At the same time, the decoder 104 decodes several macroblocks (an intra encoded macroblock, a unidirectional motion compensated macroblock or a bidirectional motion compensated macroblock) and the macroblock sequence of the decoding schemes of the several macroblocks is a macroblock sequence S4. In the related art, the macroblock sequence S3 is irrelevant to the macroblock sequence S4. When the encoder 102 is encoding a first bidirectional motion compensated macroblock and when the decoder 104 is simultaneously decoding a second bidirectional motion compensated macroblock, the encoder 102 and the decoder 104 are simultaneously in the computing mode that consumes the maximum memory bandwidth. Therefore, suddenly, much more memory bandwidth is required. Additionally, the encoder 102 and the decoder 104 both use the same memory interface circuit and the same memory device. Hence, in some moments, the memory bandwidth provided by the video signal processing system 100 is not sufficient for encoding the first bidirectional motion compensated macroblock and decoding the second bidirectionally motion compensated macroblock at the same time. This induces greatly lowering the computing speed of encoding or decoding, and therefore, the video signal processing system 100 cannot meet the requirement for real-time encoding and decoding.

As mentioned above, the encoder and the decoder of the video signal processing system according to the related art both use the same memory interface circuit and the same memory device. When the encoder and the decoder are simultaneously in the computing mode that consumes the maximum memory bandwidth, suddenly much more memory bandwidth is required. Hence, the performance of encoding and decoding is decreased. Therefore, the video signal processing system according to the related art cannot constantly meet the requirement for real-time encoding and decoding.

### SUMMARY

It is therefore an objective of the claimed invention to provide an efficient video codec system and a method thereof to solve the above-mentioned problem.

A preferred embodiment of the present invention provides a video signal processing system. The video signal processing system is utilized for encoding an encoding bit stream according to characteristics of a decoding bit stream. The encoding and decoding bit streams include a plurality of encoding schemes The video signal processing system includes: a storage device for storing data of the decoding bit stream and the encoding bit stream; and an encoder electrically connected to the storage device for encoding the encoding bit stream according to the encoding scheme of the decoding bit stream, the memory bandwidth needed for a third encoding scheme out of the plurality of encoding schemes being greater than the memory bandwidth needed for any other encoding scheme out of the plurality of encoding schemes, the encoder encoding the encoding bit stream using one of the plurality of encoding schemes except the third encoding scheme when the encoding scheme of the decoding bit stream is the third encoding scheme. The video signal processing system further includes a decoder electrically connected to the storage device for decoding the decoding bit stream and sending the encoding scheme of the decoding bit stream to the encoder.

A preferred embodiment of the present invention further provides a corresponding video signal processing method for encoding an encoding bit stream according to characteristics of a decoding bit stream. The encoding and decoding bit streams include a plurality of encoding schemes. The video signal encoding and decoding method includes: checking the encoding scheme of the decoding bit stream to decide an encoding scheme for encoding the encoding bit stream; and encoding the encoding bit stream using one of the plurality of encoding schemes except a third encoding scheme when the encoding scheme of the decoding bit stream is the third encoding scheme, the memory bandwidth needed for the third encoding scheme being greater than the memory bandwidth needed for any other encoding scheme out of the plurality of encoding schemes.

One of the advantages of the present invention is that the encoder and the decoder of the video signal processing system will not simultaneously be in the computing mode that results in consuming the maximum memory bandwidth when the encoder and the decoder of the video signal processing system use the same memory interface circuit and the same storage device. Hence, a situation in which much more memory is suddenly required will not occur, so the performance of decoding and encoding will not be decreased. Therefore, according to the present invention, the video signal processing system and the related method can constantly meet the requirement for real-time encoding and decoding.

Another advantage of the present invention is that the encoding scheme of the encoder is decided by the encoding scheme of the decoder when the encoder and the decoder of the video signal processing system use the same memory interface circuit and the same storage device. Hence, the video signal processing system and the related method can appropriately distribute the memory bandwidth required for encoding and decoding. Therefore the performance of encoding and decoding is increased.

These and other objectives of the claimed invention will no doubt become obvious to those of ordinary skill in the art after reading the following detailed description about the preferred embodiment that is illustrated in the various figures and drawings.

### BRIEF DESCRIPTION OF DRAWINGS

FIG. 1 is a functional diagram of a video signal processing system according to the related art.

FIG. 2 is a functional diagram of a video signal processing system according to the present invention.

FIG. 3 is an encoding picture sequence table of the encoding by the video signal processing system in FIG. 2.

FIG. 4 is a flowchart of the encoding by the video signal processing system in FIG. 2.

### DETAILED DESCRIPTION

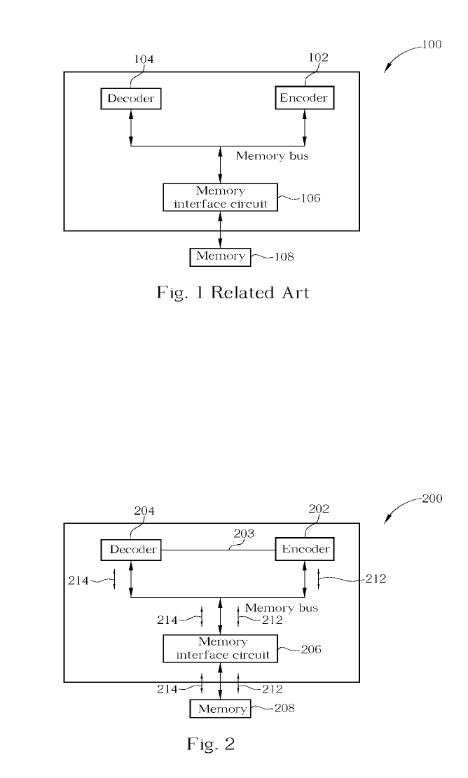

Please refer to FIG. 2. FIG. 2 is a functional diagram of a video signal processing system 200 according to one embodiment of the present invention. The video signal processing system 200 encodes an encoding bit stream 212 according to characteristics of a decoding bit stream 214. The video signal processing system 200 includes a storage device 208, which is a memory 208 in this embodiment, utilized for storing data of the decoding bit stream 214 and the encoding bit stream 212; an encoder 202 that accesses the storage device 208 through a memory interface circuit 206 and is utilized for encoding the encoding bit stream 212 according to the encoding scheme of the decoding bit stream 214; a decoder 204 that accesses the storage device 208 through the memory interface circuit 206 and is utilized for decoding the decoding bit stream 214 and sending the encoding scheme of the decoding bit stream 214 to the encoder 202 (the transmission path of the encoding scheme of the decoding bit stream 214 will be further described); and a memory interface 206 utilized for controlling access to the memory 208. Wherein, the encoding scheme of the encoding bit stream 212 corresponds to the encoding scheme of the decoding bit stream 214 such that the goal of limiting the maximum memory bandwidth needed by the encoder 202 and the decoder 204 is reached.

The encoding scheme of the encoding bit stream 212 or the decoding bit stream 214 is the intra encoding, the predictive encoding or the bidirectionally predictive encoding. In order to limit the maximum memory bandwidth that the encoder 202 and the decoder 204 need, the encoding scheme of the encoding bit stream 212 corresponds to the encoding scheme of the decoding bit stream 214 according to the present invention. The encoding scheme(s) allowed by the encoding bit stream 212 according to the present invention will be described as follows. When the encoding scheme of the decoding bit stream 214 is the intra encoding, the encoding scheme of the encoding bit stream 212 is the intra encoding, the predictive encoding or the bidirectionally predictive encoding. When the encoding scheme of the decoding bit stream 214 is the predictive encoding, the encoding scheme of the encoding bit stream 212 is the intra encoding or the predictive encoding. When the encoding scheme of the decoding bit stream 214 is the bidirectionally predictive encoding, the encoding scheme of the encoding bit stream 212 is the intra encoding. As mentioned above, with different encoding schemes of the decoding bit stream 214, though there are several corresponding encoding schemes that can be chosen for the encoding bit stream 212 according to the present invention, the better choices of encoding schemes for the encoding bit stream 212 are illustrated as follows.

Please refer to FIG. 2 and FIG. 3. FIG. 3 is an encoding picture sequence table of the encoding performed by the video signal processing system 200 in FIG. 2. Wherein “I”, “P” and “B” represent an intra encoded picture, a predictive encoded picture, and a bidirectionally predictive encoded picture, respectively. The numbers 0, 1, 2 . . . 11 following “I”, “P” or “B” respectively represent the sequence of the pictures that are being generated or decoded. Additionally, the meanings of numbers with parentheses, like (0), (1) and (2), represent the average memory bandwidth load corresponding to a reference picture data (an intra encoded picture or a predictive encoded picture) stored in the memory 208 and accessed by the encoder 202 or the decoder 204 through the memory interface circuit 206 when encoding or decoding. (0) means that the average memory bandwidth load corresponding to the intra encoded picture “I” is 0 unit. In the same manner, (1) means that the average memory bandwidth load corresponding to the predictive encoded picture “P” is 1 unit. (2) means that the average memory bandwidth load corresponding to the bidirectionally predictive encoded picture “B” is 2 units. As mentioned above, the numbers in the parentheses, like 0, 1 and 2 in (0), (1) and (2), are examples, not the real magnitude. In fact, the numbers in the parentheses only represent the relative average memory bandwidth load and are explained as follows. Firstly, when encoding or decoding an intra encoded picture, it is not necessary to refer to the previous or the future picture(s) and therefore the least memory bandwidth is required. Secondly, when encoding or decoding a predictive encoded picture “P”, it is necessary to refer to the previous reference picture and therefore more memory bandwidth is required. In the same manner, when encoding or decoding a bidirectionally predictive encoded picture “B”, it is necessary to refer to the previous and the future reference picture(s) and therefore the most memory bandwidth is required.

In the embodiment shown in FIG. 3, the beginning state of the beginning picture is intra encoding corresponding to the intra encoded picture “I”. Except the beginning picture, the encoding scheme of the encoding bit stream at each moment and the encoding scheme of the decoding bit stream at each moment are configured as follows. When the encoding scheme of the decoding bit stream 214 is the intra encoding corresponding to the intra encoded picture “I”, the encoding scheme of the encoding bit stream 212 is the bidirectionally predictive encoding “B”. When the encoding scheme of the decoding bit stream 214 is the predictive encoding “P”, the encoding scheme of the encoding bit stream 212 is the predictive encoding “P”. When the encoding scheme of the decoding bit stream 214 is the bidirectionally predictive encoding “B”, the encoding scheme of the encoding bit stream 212 is the intra encoding “I”.

As shown in FIG. 3, the sequence of the encoding scheme of the decoding bit stream is “I0, P1, B2, I3, P4, B5, I6, P7, B8, I9, P10, B11” and the sequence of the encoding scheme of the encoding bit stream 212 is “I0, P1, I2, B3, P4, I5, B6, P7, I8, B9, P10, I11”. The last row of numbers in FIG. 3, “0, 2, 2, . . . , 2”, shows that except the beginning picture, the sum of the average memory bandwidth load required for encoding (the numbers in parentheses in the third row) and the average memory bandwidth load required for decoding (the numbers in parentheses in the second row) is always 2 units. Therefore, the encoder 202 and the decoder 204 will not simultaneously be in the computing mode that results in consuming the maximum memory bandwidth so that the memory bandwidth provided by the video signal processing system 200 is insufficient for simulaneously encoding and decoding in real time. Furthermore, the remained memory bandwidth except for decoding bit stream can be fully utilized for encoding bit stream to greatly increase the performance of encoding or decoding performed by the video signal processing system 200.

The following is a description of how to transmit the encoding scheme of the decoding bit stream 214 from the decoder 204 to the encoder 202. Firstly, the decoder 204 analyzes the decoding bit stream 214 and gets the encoding scheme of the decoding bit stream 214 that is temporarily stored into the memory 208. Secondly, the encoder 202 reads the encoding scheme temporarily stored in the memory 208 and the encoder 202 will encode the encoding bit stream 212 according to the encoding scheme temporarily stored in the memory 208. However, the transmission structure is a design choice for the system and doesn't limit the scope of the present invention. In another embodiment according to the present invention, the video signal processing system 200 further includes a transmission path 203 electrically connected between the encoder 202 and the decoder 204, and utilized for transmitting the encoding scheme of the decoding bit stream 214 from the decoder 204 to the encoder 202.

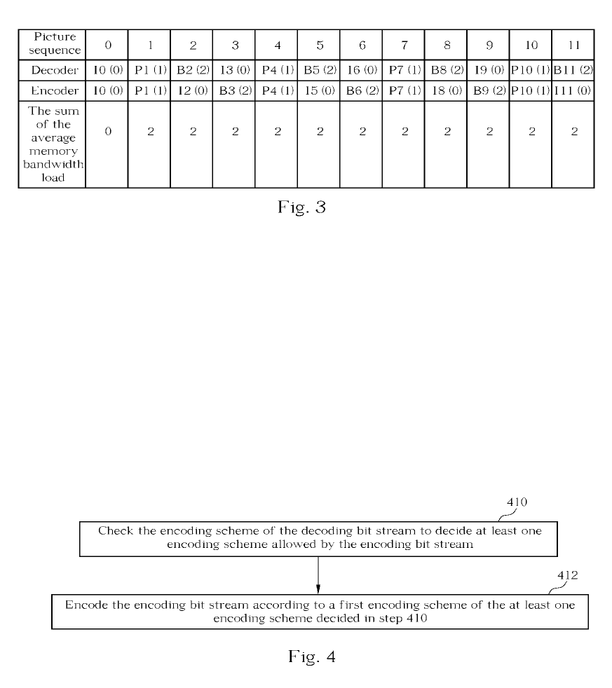

Please refer to FIG. 4. FIG. 4 is a flowchart of the encoding performed by the video signal processing system 200 in FIG. 2. In the following description, FIG. 4 is used as an example of a flowchart that describes how the video signal processing system 200 in FIG. 2 encodes a picture. The video signal processing system 200 is provided according to the present invention and a corresponding signal processing method for encoding an encoding bit stream 212 according to characteristics of a decoding bit stream 214 is also provided according to the present invention. The encoding bit stream 212 corresponds to a picture. The decoding bit stream 214 and the encoding bit stream 212 both use the same memory interface circuit 206. The method is described as follows:

Step 410: Check the encoding scheme of the decoding bit stream 214 to decide at least one encoding scheme to encode the encoding bit stream 212 such that the goal of limiting the maximum memory bandwidth required for encoding and decoding is reached.

Step 412: Encode the encoding bit stream 212 according to a first encoding scheme of the at least one encoding scheme decided in step 410.

Wherein the encoding scheme is the intra encoding, the predictive encoding or the bidirectionally predictive encoding. In order to reach the goal of limiting the maximum memory bandwidth that the encoder 202 and the decoder 204 need, the encoding scheme of the encoding bit stream 212 corresponds to the encoding scheme of the decoding bit stream 214 according to the present invention. For example, in order to reach the above-mentioned goal, the encoding scheme(s) allowed by the encoding bit stream 212 according to the present invention are described as follows. When the encoding scheme of the decoding bit stream 214 is the intra encoding, the encoding schemes allowed by the encoding bit stream 212 are the intra encoding, the predictive encoding and the bidirectionally predictive encoding. When the encoding scheme of the decoding bit stream 214 is the predictive encoding, the encoding schemes allowed by the encoding bit stream 212 are the intra encoding and the predictive encoding. When the encoding scheme of the decoding bit stream 214 is the bidirectionally predictive encoding, the encoding scheme allowed by the encoding bit stream 212 is the intra encoding.

Please refer to FIG. 4 again. In the following description, FIG. 4 is used as an example of a flowchart that describes how the video signal processing system 200 in FIG. 2 encodes a macroblock. The encoding scheme of a macroblock of an intra encoded picture is the intra encoding. The encoding scheme of a macroblock of a predictive encoded picture can be the intra encoding or the forward motion compensation encoding. Additionally, the encoding scheme of a macroblock of a bidirectionally predictive encoded picture can be the intra encoding, the forward motion compensation encoding, the backward motion compensation encoding or the bidirectional motion compensation encoding. The video signal processing system 200 is provided according to the present invention and a corresponding signal processing method for encoding an encoding bit stream 212 according to characteristics of a decoding bit stream 214 is also provided according to the present invention. The encoding bit stream 212 corresponds to a block of a picture (in the present embodiment, a block of a picture is a macroblock). The decoding bit stream 214 and the encoding bit stream 212 both use the same memory interface circuit 206. The method is described as follows:

Step 410: Check the encoding scheme of the decoding bit stream 214 to decide at least one encoding scheme to encode the encoding bit stream 212 such that the goal of limiting the maximum memory bandwidth required for encoding and decoding is reached.

Step 412: Encode the encoding bit stream 212 according to a first encoding scheme of the at least one encoding scheme decided in step 410.

Wherein the encoding scheme of the block is the intra encoding, the forward motion compensation encoding, the backward motion compensation encoding or the bidirectional motion compensation encoding. The method further includes: encoding the block according to the intra encoding when the encoding scheme of the picture is the intra encoding; encoding the block according to the intra encoding or the forward motion compensation encoding when the encoding scheme of the picture is the predictive encoding; encoding the block according to the intra encoding, the forward motion compensation encoding, the backward motion compensation encoding or the bidirectional motion compensation encoding when the encoding scheme of the picture is the bidirectionally predictive encoding. Additionally, in some video compression standards, they specify that when the encoding scheme of the picture is the bidirectionally predictive encoding, a macroblock cannot be encoded as an intra encoding macroblock. Therefore, the method further includes encoding the block according to the forward motion compensation encoding, the backward motion compensation encoding or the bidirectional motion compensation encoding when the encoding scheme of the picture is the bidirectionally predictive encoding. As mentioned above, the encoding scheme(s) of the block allowed in an encoding picture are limited to the encoding scheme(s) of the picture. Furthermore, in order to limit the maximum memory bandwidth that the encoder 202 and the decoder 204 need, the encoding scheme(s) of a block of the encoding bit stream 212 are further limited not to be some encoding schemes when the encoding scheme of a block of the decoding bit stream 214 is specific. For example, when the encoding scheme of a block of the decoding bit stream 214 is the bidirectional motion compensation encoding, the encoding scheme of a block of the encoding bit stream 212 cannot be the unidirectional motion compensation encoding or the bidirectional motion compensation encoding. Or, when the encoding scheme of a block of the decoding bit stream 214 is the unidirectional motion compensation encoding, the encoding scheme of a block of the encoding bit stream 212 cannot be the bidirectional motion compensation encoding.

According to the signal processing method according to the present invention, before encoding each block (in the present embodiment, the block is a macroblock), the video signal processing system 200 does several encoding tests according to each kind of encoding schemes to find out an encoding scheme that needs the least bits, and encodes the macroblock according to the selected encoding scheme. Since the average value, the variance, or other statistical values of the brightness of each pixel of the block imply the complexity of the block, the most appropriate encoding scheme for the block can be selected according to these statistical values. (The most appropriate encoding scheme for the block means the selected encoding scheme that needs the least bits.) This also means that the most appropriate encoding scheme can be decided by doing the encoding test according to the average value or the variance (or other statistical values) of brightness of each pixel of the block. Therefore, the signal processing method according to the present invention further includes deciding the first encoding scheme by applying an encoding test on the encoding bit stream 212 according to the at least one encoding scheme decided in step 410.

Compared with the related art, the encoder and the decoder of the video signal processing system according to the present invention use the same memory interface circuit and the same storage device, wherein the encoder and the decoder won't simultaneously be in the computing mode that results in consuming the maximum memory bandwidth. Hence, a situation where much more memory is suddenly required will not occur, and the performance of decoding and encoding will not be decreased. Therefore, according to the present invention, the video signal processing system and the related method can constantly meet the requirement for real-time encoding and decoding.

Another advantage of the present invention is that the encoding scheme of the encoder is decided by the encoding scheme of the decoder when the encoder and the decoder of the video signal processing system use the same memory interface circuit and the same storage device. Hence, the video signal processing system and the related method can appropriately distribute the memory bandwidth required for encoding and decoding. Therefore the performance of encoding and decoding is increased.

Those skilled in the art will readily observe that numerous modifications and alterations of the device may be made while retaining the teachings of the invention. Accordingly, that above disclosure should be construed as limited only by the metes and bounds of the appended claims.

1. A video signal processing system for encoding an encoding bit stream according to characteristics of a decoding bit stream, the encoding and decoding bit streams include a plurality of encoding schemes, the video signal processing system comprising:
a storage device utilized for storing data of the decoding bit stream and the encoding bit stream; and
an encoder electrically connected to the storage device for encoding the encoding bit stream according to an encoding scheme of the decoding bit stream, the memory bandwidth needed for a third encoding scheme out of the plurality of encoding schemes being greater than the memory bandwidth needed for any other encoding scheme out of the plurality of encoding schemes, the encoder encoding the encoding bit stream using one of the plurality of encoding schemes except the third encoding scheme when the encoding scheme of the decoding bit stream is the third encoding scheme.

2. The video signal processing system of claim 1, wherein the plurality of encoding schemes include three encoding schemes, and in addition to the third encoding scheme, the three encoding schemes further include a first encoding scheme and a second encoding scheme.

3. The video signal processing system of claim 2, wherein the memory bandwidth needed for the first encoding scheme is less than the memory bandwidth needed for the second encoding scheme, and the memory bandwidth needed for the second encoding scheme is less than the memory bandwidth needed for the third encoding scheme.

4. The video signal processing system of claim 3, wherein the first, second, and third encoding schemes are the intra encoding, the predictive encoding, and the bidirectionally predictive encoding, respectively.

5. The video signal processing system of claim 4, wherein when the encoding scheme of the decoding bit stream is the intra encoding, the encoding scheme of the encoding bit stream is one of the intra encoding, the predictive encoding, and the bidirectionally predictive encoding.

6. The video signal processing system of claim 4, wherein when the encoding scheme of the decoding bit stream is the predictive encoding, the encoding scheme of the encoding bit stream is one of the intra encoding, and the predictive encoding.

7. The video signal processing system of claim 4, wherein when the encoding scheme of the decoding bit stream is the bidirectionally predictive encoding, the encoding scheme of the encoding bit stream is the intra encoding.

8. The video signal processing system of claim 1, wherein the storage device is a memory, and the video signal processing system further comprises a memory interface for controlling access to the memory.

9. The video signal processing system of claim 1 further comprising:
a decoder electrically connected to the storage device for decoding the decoding bit stream and sending the encoding scheme of the decoding bit stream to the encoder.

10. A video signal encoding and decoding method for encoding an encoding bit stream according to characteristics of a decoding bit stream, the encoding and decoding bit streams include a plurality of encoding schemes, the video signal encoding and decoding method comprising:
(a) checking an encoding scheme of the decoding bit stream to decide an encoding scheme for encoding the encoding bit stream; and
(b) encoding the encoding bit stream using one of the plurality of encoding schemes except a third encoding scheme when the encoding scheme of the decoding bit stream is the third encoding scheme, the memory bandwidth needed for the third encoding scheme being greater than the memory bandwidth needed for any other encoding scheme out of the plurality of encoding schemes.

11. The video signal encoding and decoding method of claim 10, wherein the plurality of encoding schemes include three encoding schemes, and in addition to the third encoding scheme, the three encoding schemes further include a first encoding scheme and a second encoding scheme.

12. The video signal encoding and decoding method of claim 11, wherein the memory bandwidth needed for the first encoding scheme is less than the memory bandwidth needed for the second encoding scheme, and the memory bandwidth needed for the second encoding scheme is less than the memory bandwidth needed for the third encoding scheme.

13. The video signal encoding and decoding method of claim 12, wherein the first, second, and third encoding schemes are the intra encoding, the predictive encoding, and the bidirectionally predictive encoding, respectively.

14. The video signal encoding and decoding method of claim 13, wherein when the encoding scheme of the decoding bit stream is the intra encoding the encoding scheme of the encoding bit stream is one of the intra encoding, the predictive encoding, and the bidirectionally predictive encoding.

15. The video signal encoding and decoding method of claim 13, wherein when the encoding scheme of the decoding bit stream is the predictive encoding the encoding scheme of the encoding bit stream is one of the intra encoding and the predictive encoding.

16. The video signal encoding and decoding method of claim 13, wherein when the encoding scheme of the decoding bit stream is the bidirectionally predictive encoding, the encoding scheme of the encoding bit stream is the intra encoding.

17. The video signal encoding and decoding method of claim 10, wherein the decoding bit stream and the encoding bit stream are both accessed through the same memory interface circuit corresponding to a memory.

18. The video signal encoding and decoding method of claim 10, wherein the encoding bit stream is an encoding bit stream corresponding to a picture.

19. The video signal encoding and decoding method of claim 10, wherein the encoding bit stream is an encoding bit stream corresponding to a block of a picture.

20. The video signal encoding and decoding method of claim 19, wherein the block is a macroblock.

21. The video signal encoding and decoding method of claim 19, wherein the encoding scheme of the block is one of the intra encoding, the forward motion compensation encoding, the backward motion compensation encoding, and the bidirectional motion compensation encoding.

22. The video signal encoding and decoding method of claim 21 further comprising: encoding the block according to the intra encoding when the encoding scheme of the picture is the intra encoding.

23. The video signal encoding and decoding method of claim 21 further comprising: encoding the block according to one of the intra encoding and the forward motion compensation encoding when the encoding scheme of the picture is the predictive encoding.

24. The video signal encoding and decoding method of claim 21, further comprising: encoding the block according to one of the intra encoding, the forward motion compensation encoding, the backward motion compensation encoding, and the bidirectional motion compensation encoding when the encoding scheme of the picture is the bidirectionally predictive encoding.

25. The video signal encoding and decoding method of claim 21, further comprising: encoding the block according to one of the forward motion compensation encoding, the backward motion compensation encoding, and the bidirectional motion compensation encoding when the encoding scheme of the picture is the bidirectionally predictive encoding.
